(19) United States
(12) Patent Application Publication
(10) Pub. No.: US 2024/0040034 A1
(43) Pub. Date: Feb. 1, 2024

(54) MANAGEMENT OF AN ON-HOLD CALL BASED ON A USER'S PARTICIPATION IN AN ACTIVITY ON THEIR ENDPOINT

(71) Applicant: Avaya Management L.P., Durham, NC (US)

(72) Inventors: Aonkar Balkrushna Takalikar, Pune (IN); Sudhir Nivrutti Shelke, Pune (IN); Paul Roller Michaelis, Louisville, CO (US)

(21) Appl. No.: 17/876,849

(22) Filed: Jul. 29, 2022

(51) Int. Cl. H04M 3/428

(52) U.S. Cl. CPC H04M 3/4285; H04M 3/4286

(57) ABSTRACT

The technology disclosed herein enables management of a call on-hold based on a user's activity on their endpoint during the hold period. In a particular embodiment, a method includes determining that a call has been placed on hold by a system other than a first endpoint on the call. The first endpoint is operated by a user. The method further includes receiving on-hold information from the first endpoint. The on-hold information indicates an activity of the user on the first endpoint while waiting on hold. The method also includes managing the call while on-hold based on the activity.

### TECHNICAL BACKGROUND

Many enterprises, ranging from large contact centers to small offices, provide music-on-hold because callers may misinterpret silence while on hold as the call having been disconnected. While serving a purpose, listening to on-hold music is often a less than desirable experience for a caller. The music selection may not align with the caller's preferences and, even if the caller appreciates the music selection, the audio quality of the music is usually quite poor. The latter issue being a consequence of the telecommunication pathway using a voice-optimized audio compression codec, such as G.729, that distorts music transmissions. Thus, while on-hold music is still a good indicator of a call being on hold, on-hold music remains limited by constraints established when phones were only capable of exchanging voice communications over the Public Switched Telephone Network (PSTN). Modern endpoint devices, such as smartphones, have capabilities that enable users to occupy themselves with innumerable activities while they wait on hold and the on-hold experience has not kept up with those capabilities.

### SUMMARY

The technology disclosed herein enables management of a call on-hold based on a user's activity on their endpoint during the hold period. In a particular embodiment, a method includes determining that a call has been placed on hold by a system other than a first endpoint on the call. The first endpoint is operated by a user. The method further includes receiving on-hold information from the first endpoint. The on-hold information indicates an activity of the user on the first endpoint while waiting on hold. The method also includes managing the call while on-hold based on the activity.

In some examples, determining that the call has been placed on hold includes receiving a call request from the first endpoint, wherein the call request requests the call with a second endpoint, and placing the call in a queue. In those examples, managing the call may include receiving progress information from the first endpoint, wherein the progress information indicates a stopping point during the activity, and, when the call is next for connection from the queue, waiting until the stopping point to connect the call to the second endpoint.

In some examples, managing the call includes, when the call is taken off hold, pausing the activity.

In some examples, managing the call includes presenting information to the user via the first endpoint while the call is on hold, wherein the information is selected based on the activity. In those examples, the information may include an advertisement.

In some examples, the method includes determining an amount of time that the call will remain on hold and suggesting activities that conform to the amount of time.

In some examples, the activity comprises one or more of the activities including listening to music played from the first endpoint, playing a game on the first endpoint, and web browsing on the first endpoint.

In some examples, the first endpoint presents a visual indication that the call is on hold during the activity.

In some examples, the method includes notifying the first endpoint that the call will be taken off hold within a threshold amount of time, wherein the first endpoint presents a warning that the call is about to be taken off hold.

In another example, an apparatus is provided having one or more computer readable storage media and a processing system operatively coupled with the one or more computer readable storage media. Program instructions stored on the one or more computer readable storage media, when read and executed by the processing system, direct the apparatus to determine that a call has been placed on hold by a system other than a first endpoint on the call. The first endpoint is operated by a user. The program instructions further direct the apparatus to. receive on-hold information from the first endpoint. The on-hold information indicates an activity of the user on the first endpoint while waiting on hold. The program instructions also direct the apparatus to manage the call while on-hold based on the activity.

### BRIEF DESCRIPTION OF THE DRAWINGS

FIG. 1 illustrates an implementation for managing an on-hold call based on a user's activity on their endpoint.

FIG. 2 illustrates an operation to manage an on-hold call based on a user's activity on their endpoint.

FIG. 3 illustrates an implementation for managing an on-hold call based on a user's activity on their endpoint.

FIG. 4 illustrates an operational scenario for managing an on-hold call based on a user's activity on their endpoint.

FIG. 5 illustrates an operational scenario for managing an on-hold call based on a user's activity on their endpoint.

FIG. 6 illustrates a display for managing an on-hold call based on a user's activity on their endpoint.

FIG. 7 illustrates a display for managing an on-hold call based on a user's activity on their endpoint.

FIG. 8 illustrates an operation for managing an on-hold call based on a user's activity on their endpoint.

FIG. 9 illustrates a computing architecture for managing an on-hold call based on a user's activity on their endpoint.

### DETAILED DESCRIPTION

A hold management system according to the teachings herein manages a call that is on-hold based on activity of a user operating an endpoint to the call. The activity is one performed by the user with the endpoint while waiting for the call to be taken off hold (e.g., for an opposite end user to join or rejoin the call). The activity may be one of the many various activities that modern endpoint devices, such as smartphones, can provide. For example, the user may listen to music from their own music application (which is likely much higher quality than that provided over the held call), play a game, perform a task in a productivity application (e.g., word processor, email client, banking application, etc.), browse the web, or partake in some other activity offered by software executing on the endpoint. Depending on the activity, the calls management while on hold may differ. For instance, information provided to the user while on hold may differ depending on an activity of the user. In another example, the time in which the call is taken off hold may be determined based on the activity. That is, some activities may be better to interrupt than others or may have more appropriate times for interruption. The hold management system may account for those differences when determining whether to interrupt the activity. Additionally, to provide a more seamless user experience, the user's endpoint may be preconfigured by the user to automatically start a particular activity when a call hold is detected and/or rejoin the call when the call is taken off hold.

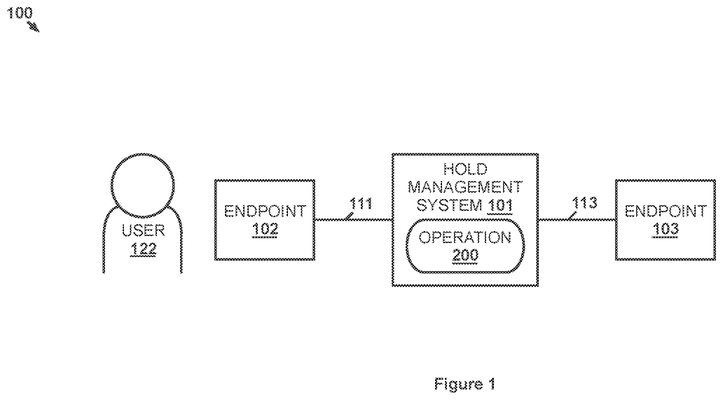

FIG. 1 illustrates implementation 100 for managing an on-hold call based on a user's activity on their endpoint. Implementation 100 includes hold management system 101, endpoint 102, and endpoint 103. Endpoint 102 and hold management system 101 communicate over communication link 111. Endpoint 103 and hold management system 101 communicate over communication link 112. Communication links 111-112 are shown as direct links but may include intervening systems, networks, and/or devices.

In operation, endpoint 102 is operated by user 122. Endpoint 102 may be a telephone, tablet computer, laptop computer, desktop computer, conference room system, or some other type of user operable computing system. Endpoint 103 may also be operated by a user, but a user is not necessary. Endpoint 103 may be a telephone, tablet computer, laptop computer, desktop computer, conference room system, Interactive Voice Response (IVR) system, Automatic Call Distributor (ACD), or some other type of computing system. Hold management system 101 is a computing system (e.g., server or collection of servers) that performs operation 200 to manage calls placed on hold by endpoint 103. The calls may be voice and/or video calls over which real-time communications are exchanged for user 122 (and any user at endpoint 103). In some examples, hold management system 101 may handle calls on hold for more than just two endpoints. For instance, hold management system 101 may be part of a contact center and may manage multiple calls on hold for the contact center, as described below. While hold management system 101 is shown separately from endpoint 103, hold management system 101 may be incorporated into endpoint 103 in some examples. Similarly, while hold management system 101 is shown in the signal path between endpoint 102 and endpoint 103, hold management system 101 may function outside of that signal path.

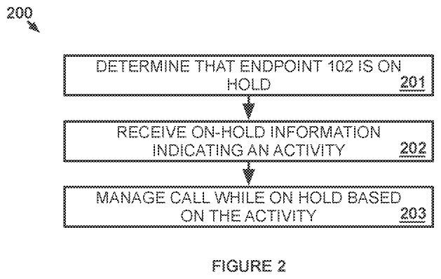

FIG. 2 illustrates operation 200 to manage an on-hold call based on a user's activity on their endpoint. In operation 200, hold management system 101 determines that a call has been placed on hold by a system other than endpoint 102 (201). The call may use any call protocol for the exchange of real-time user communications between endpoints. The call may use the PSTN and/or packet-based networks. Hold management system 101 may receive a message or signal from the system that placed the call on hold, may receive a message or signal from endpoint 102 indicating that the call has been placed on hold, may place the call on hold itself, or may determine that the call has been placed on hold in some other manner. Prior to being placed on hold, endpoint 102 may be connected to endpoint 103 or may be awaiting connection to an endpoint, such as endpoint 103. For example, user 122 may be speaking with a user of endpoint 103 over the call and endpoint 103 may be instructed by its user to place the call on hold. In an alternative example, user 122 may use endpoint 102 to place the call to endpoint 103 (either directly or to a contact center where endpoint 103 is one of multiple potential endpoints to which the call may be connected) and, prior to be connected to endpoint 103, the call is placed on hold in a queue until endpoint 103 becomes available.

While the call is on hold, hold management system 101 receives on-hold information from endpoint 102 (202). The on-hold information indicates an activity of user 122 on endpoint 102 while waiting on hold. The activity may be listening to music stored on endpoint 102 (or streamed to endpoint 102 outside of the call), playing a game, performing a productivity task, browsing the web, or participating in some other activity on endpoint 102—including combinations thereof. At its most basic, the on-hold information indicates the activity itself (e.g., listening to music or playing a game) but may indicate additional information about the activity as well. For instance, the additional information may include the specific artist, album, and/or track being played, a particular game being played, an indication of progress in a game being played (e.g., a level the user is on), a website being browsed, an application being used, or some other detail regarding user 122's activity on endpoint 102. In some examples, the on-hold information may be updated over time to account for changes to the activity or a change of activity all together. For example, if user 122 switches from playing a game to listening to music, then hold management system 101 may be provided with updated on-hold information indicating that the new activity is listening to music. Similarly, if the track being listened to changes before the call is taken off hold, then hold management system 101 may be provided with updated on-hold information indicating the new track.

In some examples, the activity may be provided through a telecom application executing on endpoint 102 to facilitate the call. For example, the telecom application may include a selection of games that user 122 can choose to play. The telecom application may provide the on-hold information to hold management system 101. The telecom application may be able to track, and provide on-hold information about, activities in other applications executing on endpoint 102 if an operating system of endpoint 102 allows cross-application tracking. Similarly, an on-hold management application may be executing on endpoint 102 to track user 122's activities while on hold and provide the on-hold information to hold management system 101.

Hold management system 101 manages the call while on-hold based on the activity, including information about the activity, included in the on-hold information (203). Managing the call may include identifying information to present to user 122 based on the activity. That information may include one or more advertisements, tips (e.g., to a game being played), or other information to present to user 122 via endpoint 102 based on the activity. For example, user 122 may be playing a game and hold management system 101 may determine that another game would be of interest to user 122. An advertisement for that other game may be presented to user 122. The advertisement may be presented via an audio channel if endpoint 103 still presents audio related to the call while on hold (e.g., even if on-hold music is not provided by hold management system 101, audio messages may still be played) and/or may be presented visually (e.g., endpoint 102 may present a banner in the current game that advertises the second game). The manner in which the information provided via endpoint 103 is presented (e.g., audibly and/or visually) may differ depending on the activity indicated by the on-hold information (e.g., when listening to music, a visual presentation may not be seen because user 122 may not be looking at endpoint 102).

In some examples, hold management system 101 may determine an amount of time until the call is taken off hold (e.g., may estimate, or receive an estimate, about the amount of time until the call is likely going to be connected from a queue). The amount of time may be presented to user 122 audibly and/or visually by endpoint 102, which may be dependent upon the activity. In further examples, hold management system 101 may use the determined amount of time to suggest activities to user 122 to fit into that amount of time. For example, if hold management system 101 determines that the call will be on hold for five minutes, then hold management system 101 may suggest a five-minute-long song, two songs that add up to five minutes, a game where completing a level takes about five minutes, or provide some other suggestion of an activity that should consume about five minutes.

Additionally, hold management system 101 may determine when to take the call off hold based on activity progress information received in the on-hold information. The progress information may indicate when a good stopping point will be reached in the user's activity and hold management system 101 may wait for that stopping point to be reached before taking the call off hold. For instance, then end of a level in a game or the end of a song may be considered good times in which the call can be taken off hold and the progress information may indicate, or at least estimate, when those points will occur (e.g., that a song will be over in 2:36). If the call is waiting in a queue, then other calls may be routed to available endpoints and then the call with endpoint 102 will be routed to whichever endpoint is available upon reaching the stopping point (e.g., endpoint 103 in this example).

Whether or not hold management system 101 determines an appropriate stopping point or simply takes the call off hold during the activity, endpoint 102 may automatically pause the activity so user 122 can participate in the call (e.g., pause the music or game and feed the audio for the call to user 122 instead of the music or game soundtrack). By pausing the activity, user 122 may return to the activity in the same state after the call has ended, is placed back on hold, or to revisit when a subsequent call is placed on hold. In some examples, hold management system 101 may present a message (e.g., audibly or visually) to user 122 via endpoint 102 that indicates when the call will be taken off hold. The message may indicate an amount of time until the call is taken off hold or may refer to the stopping point. For example, if the stopping point is at the end of a game level, the message may notify user 122 that the call will be taken off hold at the end of the level. Should user 122 want to resume the call prior to the determined stopping point, then user 122 may be able to instruct hold management system 101 not to wait (e.g., a “connect now” button may be presented in a visual banner presenting the message).

Advantageously, hold management system 101 can provide a much better experience to user 122 than the traditional low quality hold music. Hold management system 101's monitoring of on-hold information enables endpoint 102 to provide other activities to user 122 while still bringing user 122 automatically back to the call when it is taken off hold. User 122 does not need to worry about listening for when the call is taken off hold and can listen to other media instead during their on-hold activity.

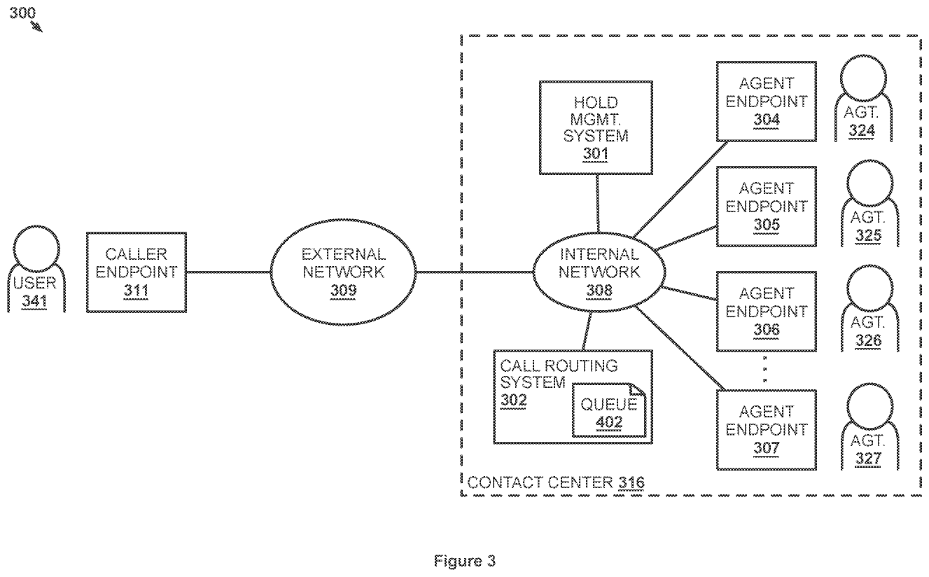

FIG. 3 illustrates implementation 300 for managing an on-hold call based on a user's activity on their endpoint. Implementation 300 includes hold management system 301, call routing system 302, agent endpoints 304-307, internal network 308, caller endpoint 311, and external network 309. Although, hold management system 301, call routing system 302, agent endpoints 304-307, and internal network 308 are part of contact center 316, no element of contact center 316 need be co-located with another. As such, internal network 308 may use external network 309, and possibly other networks, to exchange communications. While only four agent endpoints are shown in implementation 300, contact center 316 may include any number of agent endpoints.

In this example, agent endpoints 304-307 are operated by respective agents 324-327 as agents of contact center 316 and caller endpoint 311 is operated by user 341 who is a caller to contact center 316. Call routing system 302 receives calls directed towards contact center 316 and determines to which of agent endpoints 304-307 each call should be routed. If an agent system is not currently available to handle a call (or at least an agent system acceptable to call routing system 302 is not available), then call routing system 302 places the call in queue 402. When the call reaches the front of queue 402, call routing system 302 routes the call to a selected agent system when the agent system becomes available. The agent and the caller can then speak over the call established between their two endpoints. While calls are queued by call routing system 302, hold management system 301 manages the on-hold experience of the callers.

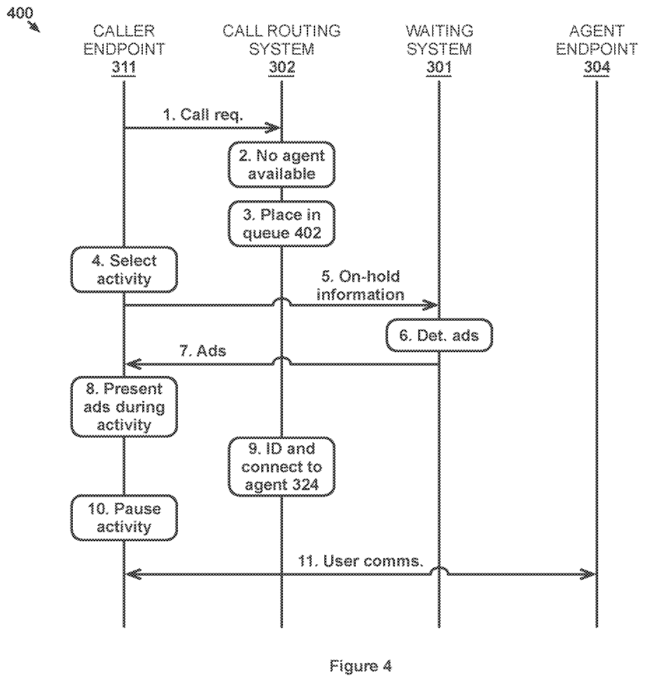

FIG. 4 illustrates operational scenario 400 for managing an on-hold call based on a user's activity on their endpoint. In operational scenario 400, user 341 wishes to talk with an agent of contact center 316. User 341 places a call request to contact center 316 at step 1 using caller endpoint 311. The call may be requested using traditional PSTN signaling, using a packet telecommunications protocol(s), or some combination thereof (e.g., a PSTN call from caller endpoint 311 may be converted to a packet-based call somewhere in external network 309). The call request is received into call routing system 302 of contact center 316. Upon receiving the call request, call routing system 302 determines that no agent is currently available to speak with user 341. As such, call routing system 302 places the call in queue 402 at step 3. When an agent becomes available, call routing system 302 connects the next call for connection from queue 402 to the endpoint of the available agent. Queue 402 may be managed as first in, first out (FIFO) or some other logic may be used by call routing system 302 to determine which call is next for connection (e.g., an upgraded service plan of a calling customer may dictate that customer's call be connected prior to other calls that have been in queue 402 longer).

Hold management system 301 manages the calls in queue 402 while they are on hold waiting for an agent to become available. Hold management system 301 may be notified by call routing system 302 when a call is placed on hold within queue 402, hold management system 301 may be notified by the endpoint of the call, or hold management system 301 may determine a particular call in on hold in some other manner. In some examples, call routing system 302 may connect the held calls to hold management system 301 while holding in queue 402. That connection may then be used by hold management system 301 to exchange information (e.g., the on-hold information described herein) with endpoints of the held calls. Call routing system 302 may provide caller endpoint 311 and/or hold management system 301 with contact information (e.g., network addresses) to exchange information between caller endpoint 311 and hold management system 301. In this example, caller endpoint 311 determines that its call with contact center 316 has been placed on hold and provides user 341 with the option to select an activity at step 4. After the activity has been selected, caller endpoint 311 transmits on-hold information indicating the selected activity to hold management system 301. Hold management system 301 uses the activity indicated in the on-hold information to determine one or more advertisements to present to user 341 via caller endpoint 311 at step 6 while user 341 is participating in the selected activity. The advertisements may be determined based on the type of activity (e.g., listening to music, playing a game, browsing the web, etc.) and/or may be determined based on details about the activity (e.g., a particular song/artist, game, website, etc.). Hold management system 301 transmits the advertisements at step 7 to caller endpoint 311. The advertisements in their entirety may be transmitted or hold management system 301 may transmit information to caller endpoint 311 directing caller endpoint 311 to retrieve the advertisements from an advertisement server. In some examples, hold management system 301 may direct the advertisement server to send the determined advertisements. The advertisements may be transmitted to caller endpoint 311 all at once or may be transmitted periodically. For instance, hold management system 301 may transmit a first advertisement for presentation and then wait a predefined period of time before transmitting a next advertisement. The periodic transmission of advertisements may continue until caller endpoint 311 is connected to an agent endpoint out of queue 402.

Caller endpoint 311 presents the advertisements to user 341 at step 8 during the activity. Visual advertisements may be presented as a banner or popup over the activity. Audible advertisements may be presented during a break in audio being presented by the activity (e.g., between songs) or at some other determined interval. In some examples, an audio channel remains open between caller endpoint 311 and hold management system 301 with hold management system 301 able to transmit the advertisement over the audio channel for playback at caller endpoint 311. If multiple advertisements are transmitted to caller endpoint 311, caller endpoint 311 may periodically present those advertisements or may present them at subsequently determined points during the activity. Alternatively, as noted above, hold management system 301 may periodically send subsequent advertisements and caller endpoint 311 may present those advertisements after receipt.

Although not shown, user 341 may select different activities while their call is on hold or details of an already selected activity may be updated (e.g., a new song may play after a previous song ends). Updated on-hold information may be transmitted to hold management system 301 indicating updates to user 341's activity. Hold management system 301 may then determine subsequent advertisements based on those updates.

Eventually, the call from caller endpoint 311 reaches the front of queue 402 and it next up for connection to an agent endpoint. In this example, call routing system 302 identifies agent 324 as being available and connects the call to agent endpoint 304 at step 9. Caller endpoint 311 determines that the call has been connected and pauses user 341's activity at step 10. Caller endpoint 311 may receive a message from hold management system 301 indicating that the activity should be paused because the call is being connected or caller endpoint 311 may determine that the call has been connected and, responsively, pause the activity to enable user 341 to speak with agent 324. Once the activity is paused, user 341 and agent 324 exchange user communications (e.g., speak to each other) over the connection between caller endpoint 311 and agent endpoint 304. Pausing the activity rather than stopping the activity, as may occur in other examples, enables user 341 to return to the activity at the same place when the call is ended or when the call is placed back on hold (e.g., agent 324 may direct agent endpoint 304 to hold the call while agent 324 performs an activity). Additionally, in some examples, hold management system 301 may use the on-hold information as a basis for providing relevant information to agent 324 once agent 324 is selected for the call. Knowledge about activity of user 341 while on hold may be useful to agent 324 when handling an issue about which user 341 is calling. If nothing else, knowledge about the activity may help agent 324 build up a rapport with user 341.

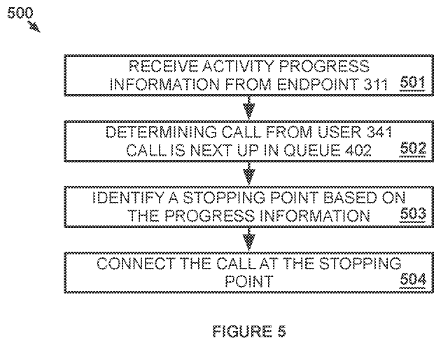

FIG. 5 illustrates operational scenario 500 for managing an on-hold call based on a user's activity on their endpoint. In the above example, caller endpoint 311 pauses the activity when the call is connected to agent endpoint 304. In operational scenario 500, the call is connected at a time that lessens the impact on the activity. For example, user 341 may be playing a game and pausing the game at a certain point may disrupt the game in such a way that user 341 cannot recover (e.g., user 341 may lose a life when returning to the game after the call because the game was paused at an inopportune time). Hold management system 301 may, therefore, determine a better point in the gameplay in which the activity should be paused (e.g., at the end of a level or a break in the action).

In operational scenario 500, hold management system 301 receives activity progress information from caller endpoint 311 (501). The activity progress information may be received in on-hold information transmitted to hold management system 301 to update hold management system 301 about user 341's activity. Hold management system 301 further determines that user 341 is next up for connection from queue 402 (502). Call routing system 302 may provide hold management system 301 with information indicating the call's timing for leaving queue 402 (e.g., an estimated amount of hold time remaining, a position within queue 402 relative to other calls, etc.). When hold management system 301 determines that the call is due for connection from queue 402, hold management system 301 uses the most up to date progress information (or requests updated progress information) to determine a stopping point for when the activity should be paused (503). The call is then connected to the available agent's system (i.e., agent endpoint 304 in the above example) after the stopping point (504). In some examples, hold management system 301 directs call routing system 302 when to connect the call at the stopping point or may direct call routing system 302 to connect the call when the first agent becomes available after the stopping point. Hold management system 301 may direct caller endpoint 311 to also pause the activity at the stopping point or may rely on caller endpoint 311 to pause the activity automatically upon the call being connected.

In some examples, if an agent becomes available prior to the stopping point, then hold management system 301 may allow call routing system 302 to connect a different call to that agent. A time threshold may be used to determine whether another call should be allowed to connect instead. If it will be longer than the threshold until the stopping point, then another call will be connected. Otherwise, the available agent will wait for the connection to the call from caller endpoint 311 at the stopping point. Similarly, once the stopping point has been reached, if no agent is presently available, user 341 may have to wait until the first agent is available after the stopping point (hopefully, user 341 would not have to wait long if agents typically become available relatively frequently). In such situations, user 341 may be given an option to continue with their activity and risk the activity being paused at a non-ideal stopping point when the agent does become available.

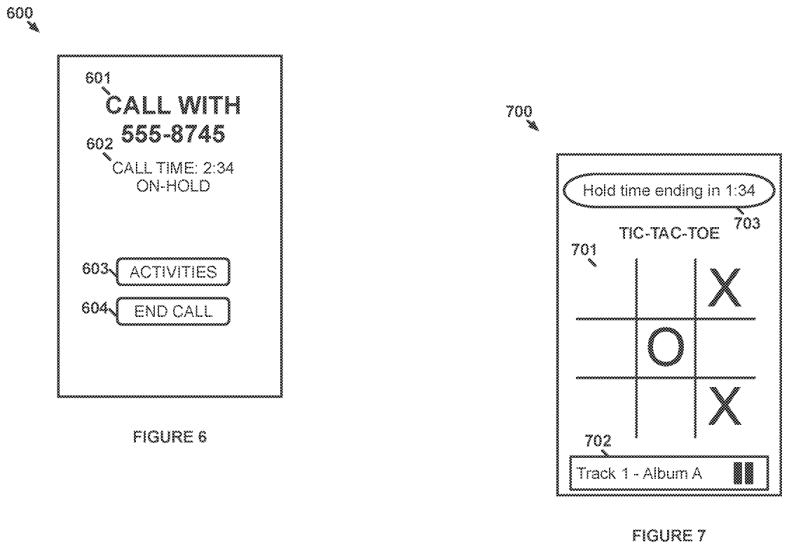

FIG. 6 illustrates display 600 for managing an on-hold call based on a user's activity on their endpoint. Display 600 is an example of what may be displayed by caller endpoint 311 when calling contact center 316. Display 600 presents called-number indicator 601, call-status indicator 602, activity-menu button 603, and end-call button 604. Called-number indicator 601 indicates that caller endpoint 311 is connected on a call to phone number ‘555-8745.’ Call-status indicator 602 indicates an amount of time in which the call has been going and indicates the call is currently on hold (e.g., within queue 402). End-call button 604, when selected by user 341, will end the current call. Activity-menu button 603, when selected by user 341, opens a menu that presents activity options for user 341. User 341 may select one or more of those options to participate in the corresponding activity or activities while waiting on hold. In this example, the activities are provided through the telecommunications client that established the call. That client handles the transmission of on-hold information to hold management system 301. Activity-menu button 603 may be displayed only upon caller endpoint 311 determining that the call has been placed on hold.

FIG. 7 illustrates display 700 for managing an on-hold call based on a user's activity on their endpoint. Display 700 is an example of display 600 after user 341 has selected activities from the menu presenting activity options after user 341 selected activity-menu button 603. In this example, user 341 selected two activities. One activity is playing the game, tic-tac-toe, and the other is listening to music from user 341's music library. As such, game 701 and music player 702 are both displayed. Display 700 also shows hold-status indicator 703 indicating how much time user 341's call is expected to remain on hold before being connected with an agent. The time may be received from hold management system 301 for display. In some examples, display 700 may present information received from hold management system 301, such as advertisements, that hold management system 301 determined based on on-hold information received from caller endpoint 311. The on-hold information may indicate that user 341 is playing tic-tac-toe and listening to track 1 of Album A. When the call is connected, caller endpoint 311 may pause the music and/or the game. Display 700 may then change back to a display like display 600 while user 341 is speaking with an agent. In some examples, activities that can be performed while speaking with an agent, such as game 701, may remain displayed for user 341 to continue.

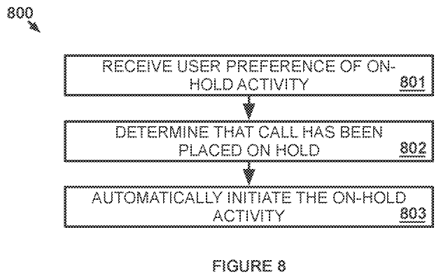

FIG. 8 illustrates operation 800 for managing an on-hold call based on a user's activity on their endpoint. Operation 800 performed by caller endpoint 311 in an example where caller endpoint 311 automatically begins a preferred activity of user 341 while on hold. This contrasts with that described in operational scenario 400 where the activity is selected after the call has been placed on hold. In operation 800, caller endpoint 311 receives a user preference indicating at least one on-hold activity in which user 341 wishes to participate when on hold (801). The user preference may be provided to a telecommunications client that facilitates calls, to the operating system of caller endpoint 311, or to some other application/software component that handles endpoint on-hold activity features described herein. The user preference is provided at a time prior to a call being placed on hold. The user preference may indicate that the activity should be started for all calls placed on hold or only a predefined subset (e.g., calls to contact centers should initiate the activity while calls directly between endpoints should not). The user preference may identify the activity broadly (e.g., identify that user 341 wants to play a game, listen to music, etc.) or more provide more detailed instructions about the activity (e.g., indicate a particular music playlist that should be played).

When user 341 places a call using caller endpoint 311 and that call gets placed on hold, caller endpoint 311 automatically determines that the call has been placed on hold (803). Caller endpoint 311 may receive a signal or message that explicitly notifies that the call has been placed on hold or may automatically determine that the call has been placed on hold based on audio received over the call. For example, on-hold music may still be provided over the call while the call is on hold even though user 341 has the option to participate in other activities instead. Caller endpoint 311 may identify the on-hold music from the voice channel of the call as being the indicator of the call being placed on hold.

In response to caller endpoint 311 determining that the call has been placed on hold, caller endpoint 311 automatically initiates the on-hold activity defined in the user preferences (803). For instance, if user 341 selected a playlist from their music library to play during the hold, caller endpoint 311 begins playing a song from that playlist. Similarly, if the user preference indicates a game to play, caller endpoint 311 opens the game. Even if on-hold music is presented over the call, the audio of whatever activity, or activities, in which user 341 is participating will take precedence (e.g., the activity's audio will be played but no the on-hold music). When the call is taken off hold, caller endpoint 311 stops or pauses the activity and returns to presenting call audio to user 341. Like when caller endpoint 311 determined the call was placed on hold, caller endpoint 311 may receive an explicit message/signal indicating that the call has been taken off hold or may recognize from the audio of the call that the call has been taken off hold (e.g., may determine that the on-hold music has stopped, or a user has begun speaking on the call).

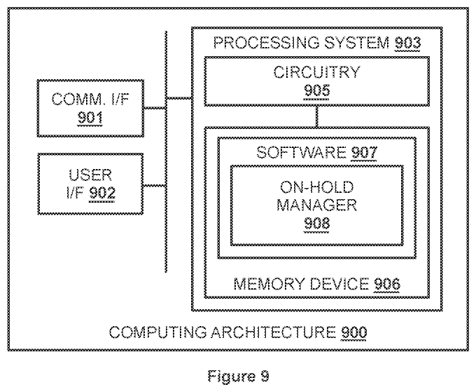

FIG. 9 illustrates computing architecture 900 for managing an on-hold call based on a user's activity on their endpoint. Computing architecture 900 is an example computing architecture for hold management systems 101 and 301, although systems 101 and 301 may use alternative configurations. Computing architecture 900 may also be used for other computing systems described herein, such as the described endpoints. Computing architecture 900 comprises communication interface 901, user interface 902, and processing system 903. Processing system 903 is linked to communication interface 901 and user interface 902. Processing system 903 includes processing circuitry 905 and memory device 906 that stores operating software 907.

Communication interface 901 comprises components that communicate over communication links, such as network cards, ports, RF transceivers, processing circuitry and software, or some other communication devices. Communication interface 901 may be configured to communicate over metallic, wireless, or optical links. Communication interface 901 may be configured to use TDM, IP, Ethernet, optical networking, wireless protocols, communication signaling, or some other communication format—including combinations thereof.

User interface 902 comprises components that interact with a user. User interface 902 may include a keyboard, display screen, mouse, touch pad, or some other user input/output apparatus. User interface 902 may be omitted in some examples.

Processing circuitry 905 comprises microprocessor and other circuitry that retrieves and executes operating software 907 from memory device 906. Memory device 906 comprises a computer readable storage medium, such as a disk drive, flash drive, data storage circuitry, or some other memory apparatus. In no examples would a computer readable storage medium of memory device 806, or any other computer readable storage medium herein, be considered a transitory form of signal transmission (often referred to as “signals per se”), such as a propagating electrical or electromagnetic signal or carrier wave. Operating software 907 comprises computer programs, firmware, or some other form of machine-readable processing instructions. Operating software 907 includes on-hold manager 908. Operating software 907 may further include an operating system, utilities, drivers, network interfaces, applications, or some other type of software. When executed by processing circuitry 905, operating software 907 directs processing system 903 to operate computing architecture 900 as described herein.

In particular, on-hold manager 908 directs processing system 903 to determine that a first endpoint of a call is on hold. The first endpoint is operated by a user. On-hold manager 908 directs processing system 903 to receive on-hold information from the first endpoint. The on-hold information indicates an activity of the user on the first endpoint while waiting on hold. On-hold manager 908 also directs processing system 903 to manage the call while on-hold based on the activity.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

1. A method comprising:
determining that a call has been placed on hold by a system other than a first endpoint on the call, wherein the first endpoint is operated by a user;
receiving on-hold information from the first endpoint, wherein the on-hold information indicates an activity of the user on the first endpoint while waiting on hold; and
managing the call while on-hold based on the activity, wherein managing the call includes determining when the call should be taken off hold based on the activity.

2. The method of claim 1, wherein determining that the call has been placed on hold comprises:
receiving a call request from the first endpoint, wherein the call request requests the call with a second endpoint; and
placing the call in a queue.

3. The method of claim 2, wherein managing the call comprises:
receiving progress information from the first endpoint, wherein the progress information indicates a stopping point during the activity; and
when the call is next for connection from the queue, waiting until the stopping point to connect the call to the second endpoint.

4. The method of claim 1, wherein managing the call comprises:
when the call is taken off hold, pausing the activity.

5. The method of claim 1, wherein managing the call comprises:
presenting information to the user via the first endpoint while the call is on hold, wherein the information is selected based on the activity.

6. The method of claim 5, wherein the information includes an advertisement.

7. The method of claim 1, comprising:
determining an amount of time that the call will remain on hold; and
suggesting activities that conform to the amount of time.

8. The method of claim 1, wherein the activity comprises one or more of the activities including:
listening to music played from the first endpoint;
playing a game on the first endpoint; and
web browsing on the first endpoint.

9. The method of claim 1, wherein the first endpoint presents a visual indication that the call is on hold during the activity.

10. The method of claim 1, comprising:
notifying the first endpoint that the call will be taken off hold within a threshold amount of time, wherein the first endpoint presents a warning that the call is about to be taken off hold.

11. An apparatus comprising:
one or more computer readable storage media;
a processing system operatively coupled with the one or more computer readable storage media; and
program instructions stored on the one or more computer readable storage media that, when read and executed by the processing system, direct the apparatus to:
determine that a call has been placed on hold by a system other than a first endpoint on the call, wherein the first endpoint is operated by a user;
receive on-hold information from the first endpoint, wherein the on-hold information indicates an activity of the user on the first endpoint while waiting on hold; and
manage the call while on-hold based on the activity, wherein management of the call includes determining when the call should be taken off hold based on the activity.

12. The apparatus of claim 11, wherein to determine that the call has been placed on hold, the program instructions direct the apparatus to:
receive a call request from the first endpoint, wherein the call request requests the call with a second endpoint; and
place the call in a queue.

13. The apparatus of claim 12, wherein to manage the call, the program instructions direct the apparatus to:
receive progress information from the first endpoint, wherein the progress information indicates a stopping point during the activity; and
when the call is next for connection from the queue, wait until the stopping point to connect the call to the second endpoint.

14. The apparatus of claim 11, wherein to manage the call, the program instructions direct the apparatus to:
when the call is taken off hold, pause the activity.

15. The apparatus of claim 11, wherein to manage the call, the program instructions direct the apparatus to:
present information to the user via the first endpoint while the call is on hold, wherein the information is selected based on the activity.

16. The apparatus of claim 15, wherein the information includes an advertisement.

17. The apparatus of claim 11, wherein the program instructions direct the apparatus to:
determine an amount of time that the call will remain on hold; and
suggest activities that conform to the amount of time.

18. The apparatus of claim 11, wherein the activity comprises one or more of the activities including:
listening to music played from the first endpoint;
playing a game on the first endpoint; and
web browsing on the first endpoint.

19. The apparatus of claim 11, wherein the program instructions direct the apparatus to:
notify the first endpoint that the call will be taken off hold within a threshold amount of time, wherein the first endpoint presents a warning that the call is about to be taken off hold.

20. One or more computer readable storage media having program instructions stored thereon that, when read and executed by a processing system, direct the processing system to:
determine that a call has been placed on hold by a system other than a first endpoint on the call, wherein the first endpoint is operated by a user;
receive on-hold information from the first endpoint, wherein the on-hold information indicates an activity of the user on the first endpoint while waiting on hold; and
manage the call while on-hold based on the activity, wherein management of the call includes determining when the call should be taken off hold based on the activity.
